(19) United States
(12) Patent Application Publication
(10) Pub. No.: US 2023/0280207 A1
(43) Pub. Date: Sep. 7, 2023

(54) PHOTOCHROMIC PIGMENT DETECTION TO DETERMINE UV OUTPUT INTENSITY OF A UV ILLUMINATING SOURCE WITHIN A REPTILE CAGE

(71) Applicant: CENTRAL GARDEN & PET COMPANY, Walnut Creek, CA (US)

(72) Inventors: Alexander CHIRBAN, Wauwatosa, WI (US); Ernie KATRIS, Hawthorn Woods, IL (US)

(21) Appl. No.: 18/178,661

(22) Filed: Mar. 6, 2023

Related U.S. Application Data
(60) Provisional application No. 63/268,895, filed on Mar. 4, 2022.

(51) Int. Cl. G01J 1/50; G01J 1/42

(52) U.S. Cl. CPC G01J 1/50; G01J 1/429

(57) ABSTRACT

The use of photochromic pigment detection to determine UV output intensity of a UV illuminating source within a reptile cage. More specifically, photochromic pigment may be placed at a location within the cage so that it may selectively be exposed to a UV illuminating source and through a color change, identify the relative intensity of UV output.

### FIELD

The present invention is directed at the use of photochromic pigment detection to determine UV output intensity of a UV illuminating source within a reptile cage. More specifically, photochromic pigment may be placed at a location within the cage so that it may selectively be exposed to a UV illuminating source and through a color change, identify the relative intensity of UV output.

### BACKGROUND

Reptiles require an adequate amount of UV light to synthesize vitamin D. Current UV technology relies upon UV bulbs where the UV output will degrade over time. For example, typically, the viability of a UV bulb may be on the order of 6 months, but it can vary. As UV light is not visible, it then becomes difficult for the consumer to verify if their UV bulb is providing the necessary UV light for the reptile needs. Consumers can attempt to deal with this issue by setting a reminder to replace their bulbs at certain fixed intervals, or they may purchase a UV detector to check UV bulb output.

For example, U.S. patent publication no. 2017/0360011 reports on a lighting system for reptiles that includes an ultraviolet including a UVA light source configured to emit UVA light and a UVB light source configured to emit UVC light and control a lighting direction of the UVB light towards a target. In addition, a UVA sensor is provided to sense the UVA light and a control unit to control the lighting characteristics of the UV light source in which the lighting characteristics include an intensity of the UVA light.

### SUMMARY

A photochromic detection system for a reptile cage to identify the intensity of UV output from a UV illuminating source, comprising a component for placement within a reptile cage, having a surface that is coated with a photochromic pigment, wherein the photochromic pigment provides a color change upon exposure to UV light. The surface having the coating with the photochromic pigment is configured so that it may be selectively exposed to the UV illuminating source wherein the color change upon exposure to UV light from the UV illuminating source identifies the intensity of UV output.

### DETAILED DESCRIPTION

The present invention stands directed at the use of photochromic pigment detection to determine UV bulb intensity in a reptile cage. More specifically, photochromic pigment may be placed at a location within the cage so that it may selective be exposed to an operating UV bulb and identify the intensity of UV output.

Reference to photochromic pigment herein is reference to a pigment that undergoes a color change in response to exposure to UV light. Such UV light is preferably in the wavelength range of 290 nm to 390 nm. The intensity of the color change is also preferably calibrated in that the color change can be relied upon to indicate the relative UV output of the UV bulb under consideration. The photochromic pigment may preferably be sourced from Hexing Pigment Co., Ltd. and is identified as a photochromic ink. Such pigment is understood to be composed of unsaturated polysterine (42.5%), calcium carbonate powder (55.0%) hardener (1.5%) and lead-free paint (1.0%). Such pigment may then be conveniently mixed into a paint and the paint is applied to a selected component of the reptile cage, as discussed more fully herein. Accordingly, upon exposure to UV light, the photochromic pigment will turn to the color purple. However, other colors may be generated upon exposure to UV light, such as yellow, magenta, blue, red and orange.

As noted, preferably, the photochromic pigment is applied to an interior component of a reptile cage, as a coating, where such coating can be selectively exposed and shielded from UV light. For example, a coating with the photochromic pigment can be selectively applied to a reptile décor component that has a lid and a body portion, where the coating is applied to the underside surface of the lid. In such manner, the user may then selectively open the lid of such décor item and evaluate the color change on the underside surface of the lid upon exposure to UV light. Such color change may then be held against a color calibration card indicating UV intensity versus color. In this manner the user can then evaluate the relative UV intensity output of the UV source and determine whether or not it may be time to change the UV source bulb at issue.

By way of another preferred example, the coating containing the photochromic pigment may be applied to the interior surface of a cupholder. Accordingly, when a cup is placed in the cupholder, the interior surfaces of the cupholder are shielded from UV light. Upon removal of a cup from the cupholder, the interior surfaces would become exposed to UV light, and the coating with the photochromic pigment would provide the user with a color change, indicative of the remaining UV intensity output of a given UV illuminating source. Placement of the cup back into the cupholder would then shield the coating with the photochromic pigment. In this manner, the lifetime and efficiency of the photochromic pigment to inform the user of UV intensity can be optimized, as the photochromic pigment is known to undergo less of a color transition to UV light, over extended periods of time.

As may therefore be appreciated, the reptile décor element can now be conveniently configured to provide the additional capability of providing the user with the ability to evaluate the UV intensity output of a UV light source. Reference to a reptile décor element may broadly be understood as any component that is placed within a reptile cage to accommodate a reptile. Such may therefore include reptile basking platforms and reptile hideaways. Such décor will typically provide underside surfaces that now can be selectively coated with photochromic pigment to provide the ability of the user to, as noted, evaluate the relative UV intensity output of their UV light source, and inform the user when their UV light source needs to be changed. In such manner, the user may avoid the need for an electronic UV sensor that is detecting the amount of UV light that is provided at the level of the reptile animal.

Accordingly, in broad aspect, it can now be appreciated that the present invention stands directed at an interior component for a reptile cage, having a surface coating containing a photochromic pigment, wherein the surface coating is one that is selectively exposed to an UV illuminating source, and the pigment provides a color change, representative of the relative UV output. Such color change may preferably be compared to a calibration card showing the intensity of color change versus UV output, so that the user may determine a proper time to replace the UV illumination source, such as a new UV bulb, so that reptile health is now more conveniently maintained.

What is claimed is:

1. A photochromic detection system for a reptile cage to identify the efficiency of UV output from a UV illuminating source, comprising:
a. a component for placement within a reptile cage, having a surface that is coated with a photochromic pigment, wherein said photochromic pigment provides a color change upon exposure to UV light;
b. said surface having said coating with said photochromic pigment is configured so that it may be selectively exposed to said UV illuminating source wherein said color change upon exposure to UV light from said UV illuminating source identifies the intensity of UV output.

2. The photochromic detection system of claim 1, wherein said component comprises a décor component.

3. The photochromic detection system of claim 1 wherein said component comprises a lid and a body portion, said lid component having an upper surface and underside surface, wherein said lid underside surface, when engaged with said body portion, is not exposed to said UV illuminating source.

4. The photochromic detection system of claim 1, further including a color calibration source, wherein said color change of said photochromic pigment can be evaluated on said color calibration source to provide an indication of an intensity output of said UV illuminating source.
